(19) United States
(12) Patent Application Publication
(10) Pub. No.: US 2025/0371839 A1
(43) Pub. Date: Dec. 4, 2025

(54) METHOD, APPARATUS, DEVICE, AND STORAGE MEDIUM FOR INFORMATION PROCESSING

(71) Applicants: Beijing Zitiao Network Technology Co., Ltd., Beijing (CN); Lemon Inc., Grand Cayman (KY)

(72) Inventors: Xiaojie Jin, Los Angeles, CA (US); Haoji Zhang, Beijing (CN); Jiashi Feng, Singapore (SG)

(21) Appl. No.: 19/223,549

(22) Filed: May 30, 2025

(30) Foreign Application Priority Data
May 31, 2024 (CN) 202410702752.6

(51) Int. Cl. G06V 10/44; G06V 10/762; G06V 20/70

(52) U.S. Cl. CPC G06V 10/44; G06V 10/762; G06V 20/70

(57) ABSTRACT

Methods, apparatus, devices and computer-readable storage media for information processing are provided. In a method, at least one video frame of a target video is obtained, memory information associated with the target video is updated based on the at least one video frame, and the memory information includes a plurality of types of memory features associated with different levels of feature granularity. In response to receiving a target request for the target video, a memory feature representation is generated based on the memory information, and the target request and the memory feature representation are provided to a target model to obtain a reply generated by the target model.

### FIELD

Example embodiments of the present disclosure generally relate to the field of computers, and more particularly, to methods, apparatuses, devices, and computer-readable storage media for information processing.

### BACKGROUND

With the development of the Internet and the multimedia technologies, the video content has an explosive growth, people's demand for real-time analysis and understanding of video content is increasingly urgent. Conventional video understanding methods mainly focus on offline scenes. When processing videos, these methods usually need to load the entire video into the model for analysis, which may encounter bottlenecks in storage and calculation efficiency when processing long video streams. In addition, when processing continuous video frames, the conventional solutions often lack effective information compression and memory mechanisms, resulting in inability to efficiently store and retrieve key information with long time sequences.

### SUMMARY

In a first aspect of the present disclosure, a method for information processing is provided. The method includes: obtaining at least one video frame of a target video; updating memory information associated with the target video based on the at least one video frame, the memory information including a plurality of types of memory features associated with different levels of feature granularity; in response to receiving a target request for the target video, generating a memory feature representation based on the memory information; and providing, to a target model, the target request and the memory feature representation, to obtain a reply generated by the target model.

In a second aspect of the present disclosure, an apparatus for information processing is provided. The apparatus includes: an obtaining module configured to obtain at least one video frame of a target video; an updating module configured to update memory information associated with the target video based on the at least one video frame, the memory information including a plurality of types of memory features associated with different levels of feature granularity; a generating module configured to in response to receiving a target request for the target video, generate a memory feature representation based on the memory information; and a response module configured to provide, to a target model, the target request and the memory feature representation, to obtain a reply generated by the target model.

In a third aspect of the present disclosure, an electronic device is provided. The electronic device includes at least one processor; and at least one memory coupled to the at least one processor and storing instructions executable by the at least one processor. The instructions, when executed by the at least one processor, causing the device to perform the method of the first aspect.

In a fourth aspect of the present disclosure, a computer-readable storage medium is provided. The computer-readable storage medium stores a computer program, and the computer program is executable by the processor to implement the method of the first aspect.

It should be understood that the content described in this content section is not intended to limit the key features or important features of the embodiments of the present disclosure, nor is it intended to limit the scope of the present disclosure. Other features of the present disclosure will become readily understood from the following description.

### BRIEF DESCRIPTION OF DRAWINGS

The above and other features, advantages, and aspects of various embodiments of the present disclosure will become more apparent from the following detailed description taken in conjunction with the accompanying drawings. In the drawings, the same or similar reference numbers refer to the same or similar elements, wherein:

FIG. 1 illustrates a schematic diagram of an information processing system according to some embodiments of the present disclosure;

FIG. 2 illustrates a flowchart of a process for information processing according to some embodiments of the present disclosure;

FIGS. 3A-3C illustrate an example process of updating memory information according to some embodiments of the present disclosure;

FIG. 4 is a schematic block diagram of an apparatus for information processing according to some embodiments of the present disclosure; and

FIG. 5 illustrates a block diagram of an electronic device capable of implementing various embodiments of the present disclosure.

### DETAILED DESCRIPTION

Embodiments of the present disclosure will be described in more detail below with reference to the accompanying drawings. While certain embodiments of the present disclosure are shown in the accompanying drawings, it should be understood that the present disclosure may be implemented in various forms, and should not be construed as limited to the embodiments set forth herein, but rather, these embodiments are provided for a more thorough and complete understanding of the present disclosure. It should be understood that the drawings and embodiments of the present disclosure are for exemplary purposes only and are not intended to limit the scope of the present disclosure.

It should be noted that the title of any section/subsection provided herein is not limiting. Various embodiments are described throughout, and any type of embodiments may be included in any section/subsection. Furthermore, the embodiments described in any section/subsection may be combined in any manner with the same section/subsection and/or any other embodiment described in different sections/subsections.

In the description of the embodiments of the present disclosure, the terms “including” and the like should be understood to include “including but not limited to”. The term “based on” should be understood as “based at least in part on”. The terms “one embodiment” or “the embodiment” should be understood as “at least one embodiment”. The term “some embodiments” should be understood as “at least some embodiments”. Other explicit and implicit definitions may also be included below. The terms “first,” “second,” and the like may refer to different or identical objects. Other explicit and implicit definitions may also be included below.

Embodiments of the present disclosure may relate to data of a user, acquisition and/or use of data, and the like. These aspects all follow the corresponding laws and regulations and related regulations. In the embodiments of the present disclosure, all data is collected, obtained, processed, processed, forwarded, used, etc., all of which are performed on the premise that the user knows and confirms. Accordingly, when implementing the embodiments of the present disclosure, the types of the data or information that may be involved, the usage scope, the usage scenario, and the like should be notified to the user and obtain the authorization of the user in an appropriate manner according to the relevant laws and regulations. The specific notification and/or authorization manner may vary according to actual situations and application scenarios, and the scope of the present disclosure is not limited in this respect.

According to the solutions in the present specification and the embodiments, for example, personal information processing is involved, processing may be performed on the premise of having a legality basis (for example, obtaining consent of a personal information subject, or necessary for performing a fulfillment contract), and processing only within a specified or agreed range. The user rejects personal information other than necessary information required by the basic function, and does not affect the basic function of the user.

As briefly mentioned above, conventional solutions usually lack effective information compression and memory mechanisms when processing successive video frames, resulting in inability to efficiently store and retrieve key information within long time sequences. Therefore, how to support real-time understanding of long videos becomes a focus problem concerned by people.

Embodiments of the present disclosure provide a solution for information processing. According to the solution, at least one video frame of the target video is obtained. Further, memory information associated with the target video is updated based on the at least one video frame, and the memory information includes a plurality of types of memory features associated with different levels of feature granularity. In addition, in response to receiving a target request for the target video, a memory feature representation is generated based on the memory information. Further, the target request and the memory feature representation are provided to the target model to obtain a reply generated by the target model.

In this way, the present disclosure may effectively compress the visual information and update the memory in real time, which significantly reduces the inference delay and the video memory consumption. In addition, embodiments of the present disclosure may support the online understanding of long videos and improve the processing efficiency of long videos.

Various example implementations of the solution will be described in detail below with reference to the accompanying drawings.

### Example System

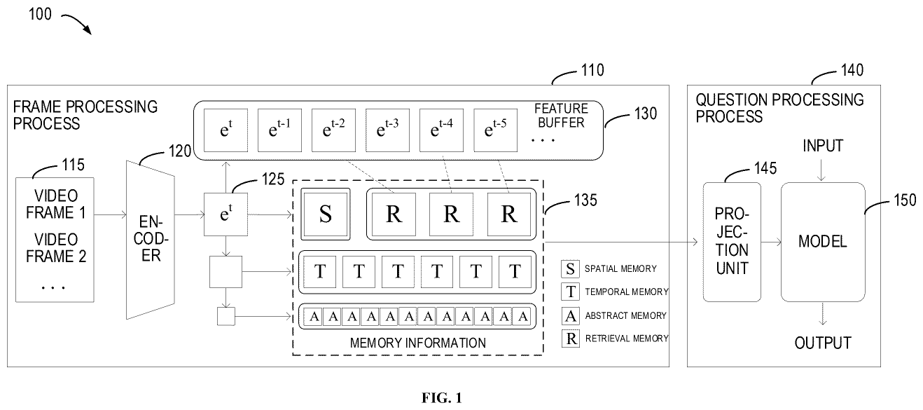

FIG. 1 illustrates a schematic diagram of an example information processing system 100 in which embodiments of the present disclosure may be implemented. As illustrated in FIG. 1, the information processing system 100 may include two processes, a frame processing process 110 and a question processing process 140.

As illustrated in FIG. 1, the frame processing process 110 may update memory information 135 of the video based on one or more video frames 115 of the video. As an example, the frame processing process 110 may encode a predetermined number of video frames 115 (e.g., one or more video frames) into corresponding feature representations 125 with an encoder (e.g., a visual encoder).

Further, the feature representation 125 may be written into the feature buffer 130 for updating the existing memory information 135. As will be described in detail below, the memory information 135 may include a plurality of types of memory features associated with different levels of feature granularity. For example, the memory information 135 may include one or more of: spatial memory associated with spatial information (S as illustrated in FIG. 1), temporal memory associated with temporal information (T as illustrated in FIG. 1), abstract memory (as illustrated in FIG. 1), and retrieval memory (R as illustrated in FIG. 1). For example, the spatial memory and the retrieval memory may correspond to the same feature granularity, the temporal memory may have a larger feature granularity (i.e., a smaller feature size), and the abstract memory may have the largest feature granularity (i.e., the smallest feature size).

The construction and updating process of the memory information 135 will be described in detail below.

In addition, the question processing process 140 may receive a target request for a video, such as a question about the video content. Accordingly, the question processing process 140 may project the feature information 135 to a feature dimension corresponding to the model 150 with the projection unit 145, and process, by the model 150, the target request based on the feature information 135 to generate a reply.

### Example Processes

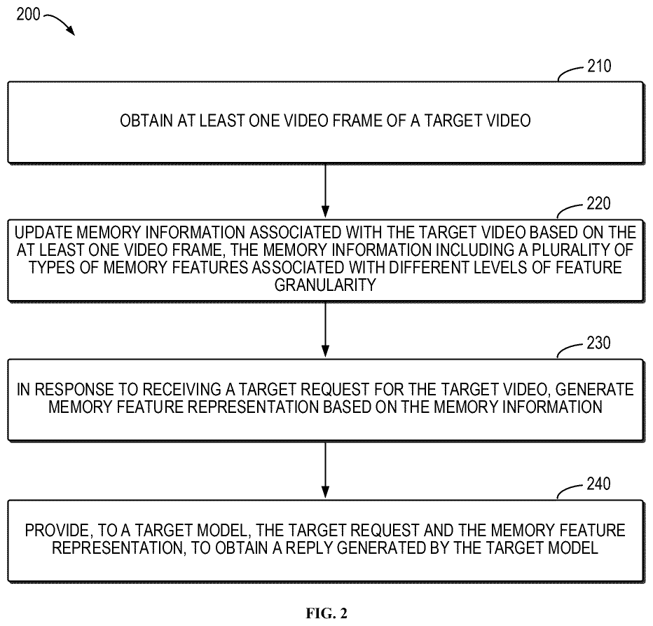

FIG. 2 illustrates a flowchart of an example process 200 for information processing according to some embodiments of the present disclosure. The process 200 may be implemented, for example, at the information processing system 100 as illustrated in FIG. 1. The process 200 will be described below with reference to FIG. 1.

As illustrated in FIG. 2, at block 210, the information processing system 100 acquires at least one video frame of the target video.

As illustrated in FIG. 1, the information processing system 100 may acquire one or more video frames 115 of the target video. For example, the information processing system 100 may obtain a single video frame 115, and update the memory information 135 based on the single video frame 115. Alternatively, the information processing system 100 may acquire a predetermined number of the plurality of video frames 115 and update the memory information 135 accordingly.

At block 220, the information processing system 100 updates memory information 135 associated with the target video based on the at least one video frame 115. The memory information includes a plurality of types of memory features associated with different levels of feature granularity.

As illustrated in FIG. 1, the information processing system 100 may encode the video frame 115 as a feature representation et 125 with the encoder 120. The feature representation 125 may be accordingly written into the feature buffer 130.

In some embodiments, the feature buffer 130 may be a feature queue with a certain length for writing the feature representation of the latest video frame. In some embodiments, for example, the feature buffer 130 may be implemented based on a first-in first-out (FIFO) queue, such that the feature representation that is earlier written may be deleted from the feature buffer 130 when the size of the feature buffer 130 exceeds a predetermined size.

The update process of the feature buffer 130 may be expressed as:

$${M}_{buff}^{t} = concat ( {g}_{pooling} ( {e}^{t} , {P}_{spa} ) , {M}_{buff}^{t - 1} ) [ 0 : {N}_{buff} , : , : ] \qquad ( 1 )$$

Where g_{pooling}( ) represents the average pooling operation of the feature to compress the feature into the corresponding feature size, N_{buff} represents the maximum size of the feature buffer 130. As an example, Pₛₚₐ may be 16, to indicate that the feature is compressed to the feature size of 16*16.

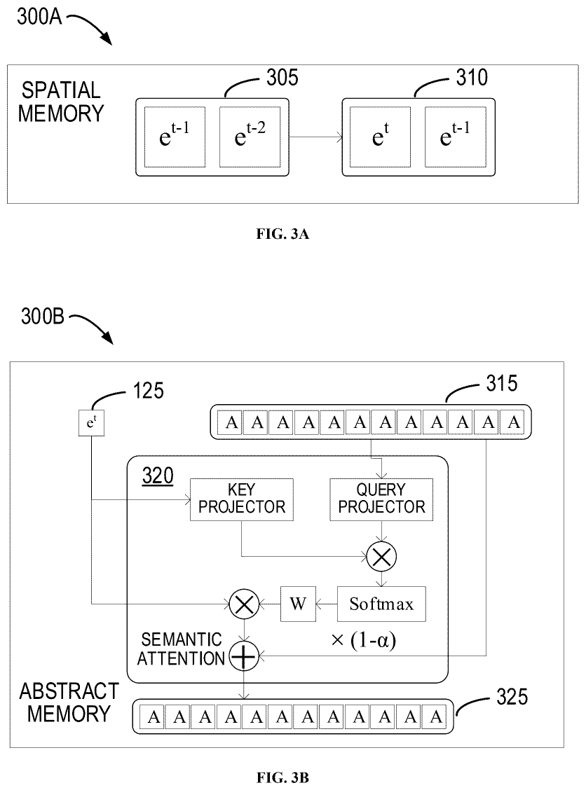

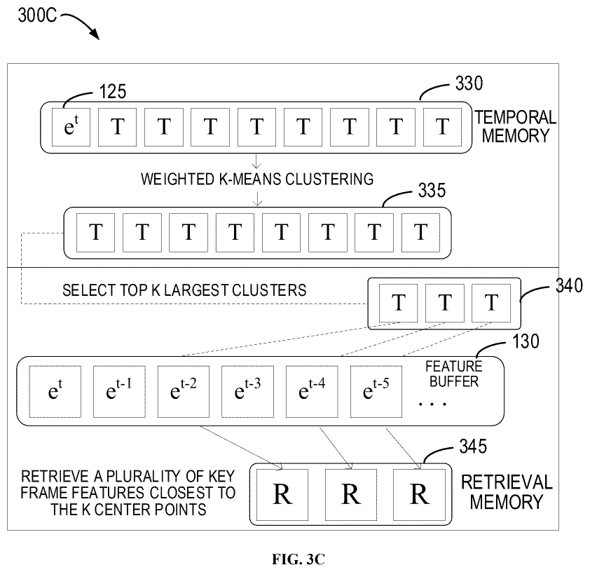

As introduced above, the memory information 135 may include a plurality of types of memory features associated with a variety of feature granularities. The updating process of various memory features will be described below with reference to FIGS. 3A to 3C.

FIG. 3A illustrates an update process of spatial memory (S). Specifically, as illustrated in FIG. 3A, for example, the spatial memory (S) may be associated with a feature queue 305 (also referred to as a first memory feature), and the feature queue 305 may have a predetermined length. As illustrated in FIG. 3A, the feature representation 125 of the video frame 115 may be written into the feature queue 305.

Specifically, if the length of the feature queue 305 reaches a maximum length, the original feature representation in the feature queue 305 may be correspondingly deleted for writing the latest feature representation 125. For example, the feature queue 305 may be implemented as a FIFO queue, so to be updated to the feature queue 310, e.g., based on the feature representation 125.

Specifically, the update process of the spatial memory (S) may be expressed as:

$${M}_{spa}^{t} = {M}_{buff}^{t} [ 0 : {N}_{spa} , : , : ] \qquad ( 2 )$$

Where Nₛₚₐ represents the maximum length of the feature queue 305 corresponding to the spatial memory (S). For example, as illustrated in FIG. 3A, the maximum length is 2.

FIG. 3B illustrates an update process of abstract memory (A). As illustrated in FIG. 3B, the information processing system 100 may update the abstract memory (A) 315 (also referred to as a fourth memory feature) with the feature representation 125 of the video frame 115.

Specifically, as illustrated in FIG. 3B, the information processing system 100 may update, by the semantic attention model 320, the abstract memory 315 based on the feature representation 125 to obtain an updated abstract memory 325.

In some embodiments, the semantic attention model 320 may acquire the first projection representation (e.g., K) corresponding to the feature representation 125 with a key projector and acquire the second projection representation (e.g., Q) corresponding to the abstract memory 315 with a query projector.

Further, based on a dot product of the first projection representation and the second projection representation, the semantic attention model 320 may determine a weight coefficient W with a softmax layer. Specifically, W may be expressed as:

$$W = {QK}^{T} \qquad ( 3 )$$

$$W = Softmax ( W , dim = 1 ) \qquad ( 4 )$$

The semantic attention model 320 may further apply the weight coefficient W to the feature representation 125, and apply a predetermined attenuation coefficient α to the abstract memory 320, to obtain the updated abstract memory 325. This process may be expressed as:

$${M}_{abs} = ( 1 - α ) {M}_{abs} + W * {e}^{t} \qquad ( 5 )$$

Where M_{abs} represents the abstract memory (A).

The above update process of the abstract memory (A) may also be abstracted as:

$${M}_{abs}^{t} = {f}_{SA} ( {M}_{abs}^{t - 1} , {g}_{pooling} ( {e}^{t} , {P}_{abs} ) , {N}_{abs} ) \qquad ( 6 )$$

Where f_{SA} represents the processing process of the semantic attention model 320, N_{abs} represents the length of the abstract memory 320, P_{abs} may indicate the feature size of the abstract memory (A). For example, P_{abs} may be 1 to indicate that feature e^{t} is compressed to the feature representation of 1*1.

Thus, the abstract memory (A) may have a larger feature granularity than that of the spatial memory (S), i.e., the feature size of the abstract memory (A) may be smaller than the feature size of the spatial memory (S). For example, the abstract memory (A) may correspond to a feature size of 1*1, and the spatial memory (S) may correspond to the feature size of 16*16.

FIG. 3C illustrates an update process of time memory (T) and retrieval memory (R). As illustrated in FIG. 3C, the information processing system 100 may update the temporal memory (T) 330 (also referred to as a second memory feature) with the feature representation 125 of the video frame 115.

Specifically, the information processing system 100 may compress the feature representation 125 of the video frame 115 to a feature size corresponding to the time memory (T), and update the feature queue 330 corresponding to the time memory (T) based on the compressed feature representation 125. As an example, the feature size corresponding to the time memory (T) may be 4*4, and its feature granularity may be greater than that of the spatial memory (S) and less than that of the abstract memory (A).

As an example, as illustrated in FIG. 3C, the information processing system 100 may write the compressed feature representation 125 into the feature queue 330. In some embodiments, if the length of the feature queue 330 does not exceed the maximum length, the feature queue 330 may not perform subsequent processing. Conversely, as illustrated in FIG. 3C, if the length of feature queue 330 exceeds the maximum length, the information processing system 100 may further compress feature queue 330.

Specifically, the information processing system 100 may compress the feature queue 330 into a feature queue 335 with the predetermined size by clustering the elements in the feature queue 330. As an example, the information processing system 100 may compress feature queue 330 into the feature queue 335, e.g., with weighted K-means clustering. This process may be expressed as:

$${M}_{tem}^{t} = {g}_{wkmeans} ( concat ( {g}_{pooling} ( {e}^{t} , {P}_{tem} ) , {M}_{tem}^{t - 1} ) , {N}_{tem} ) \qquad ( 7 )$$

Where Nₜₑₘ represents the maximum length of the feature queue 330, Pₜₑₘ may indicate the feature size of the time memory (T). For example, Pₜₑₘ may be 4, to indicate that the feature size of the time memory (T) is 4*4.

In some embodiments, the information processing system 100 may further update the retrieval memory (R) based on the updated feature queue 335. As illustrated in FIG. 3C, the information processing system 100 may determine at least one clustering element 340 from the feature queue 335. The number of a plurality of video frames corresponding to the at least one clustering element 340 is greater than a predetermined number. For example, the at least one clustering element 340 may correspond to the largest K clusters in the feature queue 335.

Further, the information processing system 100 may obtain the feature representation of the plurality of key frames corresponding to the K clusters from the feature buffer 130, as the updated query memory 345. The process may be expressed as:

$${M}_{ret}^{t} = {g}_{retrieve} ( {M}_{buff}^{t} , {M}_{tem}^{t} , {N}_{ret} ) \qquad ( 8 )$$

Where gᵣₑₜᵣᵢₑᵥₑ represents the feature retrieval process introduced above, and Nᵣₑₜ represents the maximum length of the retrieval memory (R).

Thus, the retrieval memory (R) may have the same feature granularity (e.g., the feature size of 16*16) as the spatial memory (S), the temporal memory (T) may have a larger feature granularity (e.g., the feature size of 4*4), and the abstract memory (A) may have the largest feature granularity (e.g., the feature size of 1*1).

Therefore, based on the design manner of the memory information (also referred to as STAR memory), embodiments of the present disclosure achieve may efficient information compression, fast access, long-term memory maintenance and complex semantic understanding of long video streams by combining the instant visual information processing of the spatial memory, long-term dynamic information integration of the time memory, advanced semantic understanding of the abstract memory, and precise detailed information retrieval of the retrieval memory. In addition, embodiments of the present disclosure may also simulate the human cognitive process, significantly reducing the delay and resource consumption of the real-time processing, and improving efficiency and performance of video understanding.

With continued reference to FIG. 2, at block 230, the information processing system 100 generates a memory feature representation based on the memory information in response to receiving a target request for the target video.

Specifically, as illustrated in FIG. 1, the question processing process 140 may map the memory information 135 to the feature dimension corresponding to the model 150 with the projection unit 145, so as to generate the memory feature representation.

At block 240, the information processing system 100 provides the target request and the memory feature representation to the target model, to obtain a reply generated by the target model.

Specifically, as illustrated in FIG. 1, for example, the model 150 may generate the corresponding output result based on the received memory feature representation and the target request as the reply. It should be understood that the target model may be implemented, for example, based on an appropriate machine learning model (such as a language model, etc.).

Based on the processes described above, embodiments of the present disclosure may achieve real-time processing of the video stream. In addition, the design of the information system 100 may support the parallel execution of multiple processing steps (e.g., perception, memory, recall, and answer), thereby improving overall processing speed and performance.

In another aspect, embodiments of the present disclosure also provide a method for constructing a test data set for testing the performance of the model 150 as described with reference to FIG. 1.

Specifically, text description content associated with a target segment of a sample video may be generated with the language model. For example, the sample video may be divided into a plurality of segments of a predetermined length, and the text description content for the plurality of segments may be generated with a language model. Further, the text description content may be associated with a timestamp of the corresponding segment.

Further, the text description content corresponding to the plurality of segments may be summarized with the language model, to reduce redundancy of the text description content. During the summarization, the timestamp corresponding to the text description content may be preserved.

Additionally, a plurality of answer question pairs may be generated based on the text description content with the language model. The answer question pair may, for example, be only related to the text description content prior to the corresponding timestamp.

Further, the test data set may be constructed based on the plurality of answer question pairs and the corresponding time information. For example, specific answer question pairs may be screened or filtered based on the relevance of the answer question pair to the video content, and a final test data set may be formed.

Thus, embodiments of the present disclosure may further support evaluation of understanding performance for long video streams.

### Example Apparatus and Device

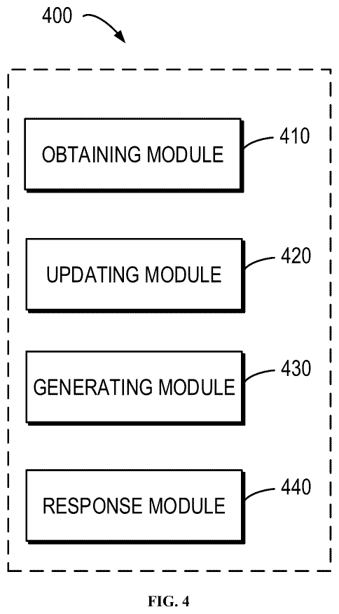

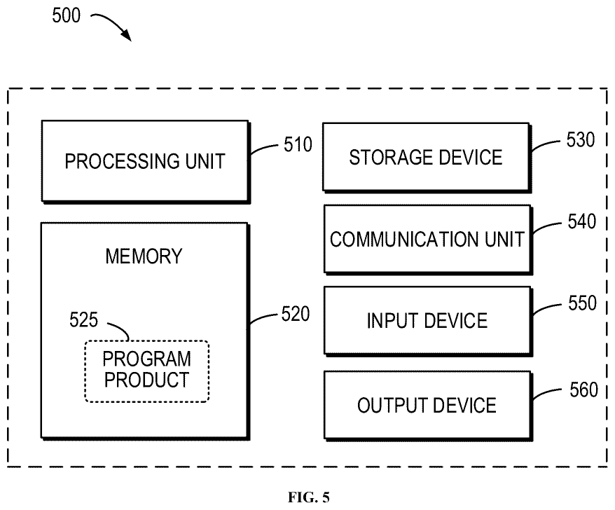

Embodiments of the present disclosure further provide a corresponding apparatus for implementing the above method or process. FIG. 4 is a schematic block diagram of an apparatus 400 for information processing according to some embodiments of the present disclosure. The apparatus 400 may be implemented or included in an electronic device. The various modules/components in the apparatus 400 may be implemented by hardware, software, firmware, or any combination thereof.

As illustrated in FIG. 4, the apparatus 400 includes an obtaining module 410, an updating module 420, a generating module 430 and a response module 440. The obtaining module 410 is configured to obtain at least one video frame of a target video. The updating module 420 is configured to update memory information associated with the target video based on the at least one video frame. The memory information includes a plurality of types of memory features associated with different levels of feature granularity. The generating module 430 is configured to in response to receiving a target request for the target video, generate a memory feature representation based on the memory information. The response module 440 is configured to provide the target request and the memory feature representation to the target model to obtain the reply generated by the target model.

In some embodiments, the generating module 430 is further configured to project the memory information to a feature dimension matching the target model to generate the memory feature representation.

In some embodiments, the first process is configured to update the memory information, and the second process is configured to generate the memory feature representation and generate the reply.

In some embodiments, the memory information includes a first memory feature associated with spatial information of the target video.

In some embodiments, the updating module 420 is further configured to: obtain a first feature representation of the at least one video frame; and update a first queue associated with the first memory feature based on the first feature representation.

In some embodiments, the memory information includes a second memory feature associated with time information of the target video.

In some embodiments, the updating module 420 is further configured to: obtain a first feature representation of the at least one video frame; convert the first feature representation into a second feature representation, a size of the second feature representation being less than a size of the first feature representation; and update a second queue associated with the second memory feature based on the second feature representation.

In some embodiments, the updating module 420 is further configured to: write the second feature representation into the second queue; and in response to a first size of the second queue being greater than a threshold, compress, by clustering elements in the second queue, the second queue to a predetermined size.

In some embodiments, the memory information further includes a third memory feature, and the updating module 420 is further configured to: determine at least one clustering element from the second queue, a number of a plurality of video frames corresponding to the at least one clustering element being greater than a predetermined number; and obtain the first feature representation of the plurality of video frames as the third memory feature.

In some embodiments, the memory information includes a fourth memory feature, and the updating module 420 is further configured to: obtain a first feature representation of the at least one video frame; and provide, to a semantic attention model, the first feature representation and the fourth memory feature, to obtain the updated fourth memory feature.

In some embodiments, the semantic attention model is configured to: obtain a first projection representation corresponding to the first feature representation and a second projection representation corresponding to the fourth memory feature; determine a weight coefficient based on the first projection representation and the second projection representation; and obtain the updated fourth memory feature by applying the weight coefficient to the first feature representation and applying a predetermined attenuation coefficient to the fourth memory feature representation.

In some embodiments, the apparatus 400 further includes a test module configured to test the target model based on the test data set. The test data set is constructed by: generating, by a language model, text description content associated with a target segment of a sample video; generating, by the language model, a plurality of answer question pairs based on the text description content; and constructing the test dataset based on the plurality of answer question pairs and corresponding time information.

FIG. 5 illustrates a block diagram of an electronic device 500 in which one or more embodiments of the present disclosure may be implemented. It should be understood that the electronic device 500 illustrated in FIG. 5 is merely exemplary and should not constitute any limitation on the functionality and scope of the embodiments described herein. The electronic device 500 illustrated in FIG. 5 may be used for the information processing system 100 illustrated in FIG. 1.

As illustrated in FIG. 5, the electronic device 500 is in the form of a general-purpose electronic device. Components of the electronic device 500 may include, but are not limited to, one or more processors or processing units 510, a memory 520, a storage device 530, one or more communication units 540, one or more input devices 550, and one or more output devices 560. The processing unit 510 may be an actual or virtual processor and capable of performing various processes according to programs stored in the memory 520. In multiprocessor systems, multiple processing units execute computer-executable instructions in parallel to improve parallel processing capabilities of electronic device 500.

Electronic device 500 typically includes a plurality of computer storage media. Such media may be any available media accessible to the electronic device 500, including, but not limited to, volatile and non-volatile media, removable and non-removable media. The memory 520 may be volatile memory (e.g., registers, caches, random access memory (RAM)), non-volatile memory (e.g., read-only memory (ROM), electrically erasable programmable read-only memory (EEPROM), flash memory), or some combination thereof. Storage device 530 may be a removable or non-removable medium and may include a machine-readable medium, such as a flash drive, a magnetic disk, or any other medium that may be used to store information and/or data and that may be accessed within electronic device 500.

The electronic device 500 may further include additional removable/non-removable, volatile/non-volatile storage media. Although not illustrated in FIG. 5, a disk drive for reading or writing from a removable, nonvolatile magnetic disk (e.g., a “floppy disk”) and an optical disk drive for reading or writing from a removable, nonvolatile optical disk may be provided. In these cases, each drive may be connected to a bus (not illustrated) by one or more data media interfaces. The memory 520 may include a computer program product 525 having one or more program modules configured to perform various methods or actions of various embodiments of the present disclosure.

The communication unit 540 is configured to communicate with another electronic device through a communication medium. Additionally, the functionality of components of the electronic device 500 may be implemented in a single computing cluster or multiple computing machines capable of communicating over a communication connection. Thus, the electronic device 500 may operate in a networked environment using logical connections with one or more other servers, network personal computers (PCs), or another network node.

The input device 550 may be one or more input devices such as a mouse, a keyboard, a trackball, or the like. The output device 560 may be one or more output devices, such as a display, a speaker, a printer, or the like. The electronic device 500 may also communicate with one or more external devices (not illustrated) through the communication unit 540 as needed, external devices such as storage devices, display devices, etc., communicate with one or more devices that enable a user to interact with the electronic device 500, or communicate with any device (e.g., a network card, a modem, etc.) that enables the electronic device 500 to communicate with one or more other electronic devices. Such communication may be performed via an input/output (I/O) interface (not illustrated).

According to example implementations of the present disclosure, there is provided a computer-readable storage medium having computer-executable instructions stored thereon, wherein the computer-executable instructions are executed by a processor to implement the method described above. According to example implementations of the present disclosure, a computer program product is further provided, the computer program product being tangibly stored on a non-transitory computer-readable medium and including computer-executable instructions, the computer-executable instructions being executed by a processor to implement the method described above.

Aspects of the present disclosure are described herein with reference to flowcharts and/or block diagrams of methods, apparatuses, devices, and computer program products implemented in accordance with the present disclosure. It should be understood that each block of the flowchart and/or block diagram, and combinations of blocks in the flowcharts and/or block diagrams, may be implemented by computer readable program instructions.

These computer-readable program instructions may be provided to a processing unit of a general-purpose computer, special purpose computer, or other programmable data processing apparatus to produce a machine, such that the instructions, when executed by a processing unit of a computer or other programmable data processing apparatus, produce means to implement the functions/acts specified in the flowchart and/or block diagram. These computer-readable program instructions may also be stored in a computer-readable storage medium that cause the computer, programmable data processing apparatus, and/or other devices to function in a particular manner, such that the computer-readable medium storing instructions includes an article of manufacture including instructions to implement aspects of the functions/acts specified in the flowchart and/or block diagram(s).

The computer-readable program instructions may be loaded onto a computer, other programmable data processing apparatus, or other apparatus, such that a series of operational steps are performed on a computer, other programmable data processing apparatus, or other apparatus to produce a computer-implemented process such that the instructions executed on a computer, other programmable data processing apparatus, or other apparatus implement the functions/acts specified in the flowchart and/or block diagram block or blocks.

The flowchart and block diagrams in the figures show architecture, functionality, and operation of possible implementations of systems, methods, and computer program products according to various implementations of the present disclosure. In this regard, each block in the flowchart or block diagram may represent a module, program segment, or portion of an instruction that includes one or more executable instructions for implementing the specified logical function. In some alternative implementations, the functions noted in the blocks may also occur in a different order than noted in the figures. For example, two consecutive blocks may actually be performed substantially in parallel, which may sometimes be performed in the reverse order, depending on the functionality involved. It is also noted that each block in the block diagrams and/or flowchart, as well as combinations of blocks in the block diagrams and/or flowchart, may be implemented with a dedicated hardware-based system that performs the specified functions or actions, or may be implemented in a combination of dedicated hardware and computer instructions.

Various implementations of the present disclosure have been described above, which are exemplary, not exhaustive, and are not limited to the implementations disclosed. Many modifications and variations will be apparent to those of ordinary skill in the art without departing from the scope and spirit of the various implementations illustrated. The selection of the terms used herein is intended to best explain the principles of the implementations, practical applications, or improvements to techniques in the marketplace, or to enable others of ordinary skill in the art to understand the various implementations disclosed herein.

What is claimed is:

1. A method for information processing, comprising:
obtaining at least one video frame of a target video;
updating memory information associated with the target video based on the at least one video frame, the memory information comprising a plurality of types of memory features associated with different levels of feature granularity;
in response to receiving a target request for the target video, generating a memory feature representation based on the memory information; and
providing, to a target model, the target request and the memory feature representation, to obtain a reply generated by the target model.

2. The method of claim 1, wherein generating the memory feature representation based on the memory information comprises:
projecting the memory information to a feature dimension matching the target model, to generate the memory feature representation.

3. The method of claim 1, wherein a first process is configured to update the memory information, and a second process is configured to generate the memory feature representation and generate the reply.

4. The method of claim 1, wherein the memory information comprises a first memory feature associated with spatial information of the target video.

5. The method of claim 4, wherein updating the memory information associated with the target video based on the at least one video frame comprises:
obtaining a first feature representation of the at least one video frame; and
updating a first queue associated with the first memory feature based on the first feature representation.

6. The method of claim 1, wherein the memory information comprises a second memory feature associated with time information of the target video.

7. The method of claim 6, wherein updating the memory information associated with the target video based on the at least one video frame comprises:
obtaining a first feature representation of the at least one video frame;
converting the first feature representation into a second feature representation, a size of the second feature representation being less than a size of the first feature representation; and
updating a second queue associated with the second memory feature based on the second feature representation.

8. The method of claim 7, wherein updating the second queue associated with the second memory feature based on the second feature representation comprises:
writing the second feature representation into the second queue; and
in response to a first size of the second queue being greater than a threshold, compressing, by clustering elements in the second queue, the second queue to a queue with a predetermined size.

9. The method of claim 8, wherein the memory information further comprises a third memory feature, and updating the memory information associated with the target video based on the at least one video frame further comprises:
determining at least one clustering element from the second queue, wherein a number of a plurality of video frames corresponding to the at least one clustering element is greater than a predetermined number; and
obtaining the first feature representation of the plurality of video frames as the third memory feature.

10. The method of claim 1, wherein the memory information comprises a fourth memory feature, and updating the memory information associated with the target video based on the at least one video frame comprises:
obtaining a first feature representation of the at least one video frame; and
providing, to a semantic attention model, the first feature representation and the fourth memory feature, to obtain the updated fourth memory feature.

11. The method of claim 10, wherein the semantic attention model is configured to:
obtain a first projection representation corresponding to the first feature representation and a second projection representation corresponding to the fourth memory feature;
determine a weight coefficient based on the first projection representation and the second projection representation; and
obtain the updated fourth memory feature by applying the weight coefficient to the first feature representation and applying a predetermined attenuation coefficient to the fourth memory feature representation.

12. The method of claim 1, further comprising:
testing the target model based on a test dataset, the test dataset being constructed by:
generating, by a language model, text description content associated with a target segment of a sample video;
generating, by the language model, a plurality of answer question pairs based on the text description content; and
constructing the test dataset based on the plurality of answer question pairs and corresponding time information.

13. An electronic device, comprising:
at least one processor; and
at least one memory coupled to the at least one processor and storing instructions executable by the at least one processor, the instructions, when executed by the at least one processor, causing the electronic device to perform at least:
obtaining at least one video frame of a target video;
updating memory information associated with the target video based on the at least one video frame, the memory information comprising a plurality of types of memory features associated with different levels of feature granularity;
in response to receiving a target request for the target video, generating a memory feature representation based on the memory information; and
providing, to a target model, the target request and the memory feature representation, to obtain a reply generated by the target model.

14. The electronic device of claim 13, wherein generating the memory feature representation based on the memory information comprises:
projecting the memory information to a feature dimension matching the target model, to generate the memory feature representation.

15. The electronic device of claim 13, wherein a first process is configured to update the memory information, and a second process is configured to generate the memory feature representation and generate the reply.

16. The electronic device of claim 13, wherein the memory information comprises a first memory feature associated with spatial information of the target video.

17. The electronic device of claim 16, wherein updating the memory information associated with the target video based on the at least one video frame comprises:
obtaining a first feature representation of the at least one video frame; and
updating a first queue associated with the first memory feature based on the first feature representation.

18. The electronic device of claim 13, wherein the memory information comprises a second memory feature associated with time information of the target video.

19. The electronic device of claim 18, wherein updating the memory information associated with the target video based on the at least one video frame comprises:
obtaining a first feature representation of the at least one video frame;
converting the first feature representation into a second feature representation, a size of the second feature representation being less than a size of the first feature representation; and
updating a second queue associated with the second memory feature based on the second feature representation.

20. A non-transitory computer-readable storage medium having a computer program stored thereon, the computer program being executable by a processor to implement acts comprising:
obtaining at least one video frame of a target video;
updating memory information associated with the target video based on the at least one video frame, the memory information comprising a plurality of types of memory features associated with different levels of feature granularity;
in response to receiving a target request for the target video, generating a memory feature representation based on the memory information; and
providing, to a target model, the target request and the memory feature representation, to obtain a reply generated by the target model.
